(19) United States
(12) Patent Application Publication
(10) Pub. No.: US 2011/0316330 A1
(43) Pub. Date: Dec. 29, 2011

(54) Continuous Rubber/Metal Hybrid Track with Replaceable Components

(75) Inventor: Richardson J. Doyle, Bangkok (TH)

(73) Assignee: McLaren Group Holdings PTE. Ltd.

(21) Appl. No.: 12/822,123

(22) Filed: Jun. 23, 2010

(51) Int. Cl. B62D 55/28

(52) U.S. Cl. 305/165; 305/187

(57) ABSTRACT

A continuous track with replaceable components permits a light weight tracked vehicle to benefit from the cost savings associated with repairable tracks. Each repairable track includes two parallel continuous belts, each belt includes embedded plates to reinforce the belts and distribute the load applied by the vehicle drive train and the load applied by the shoe to the belts. Each shoe assembly engages the parallel belts and includes a track guide, a shoe plate and a shoe. The number, separation and orientation of the shoe assemblies are preset for a set of parallel belts, however shoe assemblies and the elements of the shoe assemblies may be used for many different belt sets. Any suitable fasteners may be used to secure each shoe assembly to the belts.

### FIELD OF THE INVENTIONS

The inventions described below relate to the field of tracks and crawlers for tracked vehicles and more specifically to rebuildable or repairable continuous tracks with replaceable components.

### BACKGROUND OF THE INVENTIONS

Conventional repairable tracks for construction equipment are formed primarily of metal and are responsible for many problems that plague the equipment and damage any surface on which they operate. For example, most tracked equipment does not have suspension and thus any vibrations or shocks created, fostered or enhanced in the tracks, travels directly to and through the equipment and contributes to operator fatigue and equipment wear and failure. Additionally, conventional repairable tracks are heavy and increase the load that must be supported by the terrain on which the vehicle operates and the conventional repairable tracks often destroy the terrain.

For vehicles outfitted with steel tracks, the tracks have a pin and bushing system to enable flexibility and bending of the tracks. Conventional pin and bushing tracks are a metal to metal flexing point that is the main cause of wear on the steel track system. When dirt, sand, or other debris enters between the pin and bushing the wear is accelerated. Metal tracks are destroyed by sand getting between the pin and bushing. The pin and bushing system used on steel tracks only flex at the pin and bushing point. The conventional pin and bushing system makes the steel tracks slower, heavier, and having more vibration. In a steel track if the pitch between the driving pins is long, then the track is also less flexible.

Conventional rubber tracks are generally molded into a one piece track. This means if one section of the track is damaged, then the whole track cannot be used and has to be thrown away. Since a molded continuous rubber track does not have replaceable parts, the entire track is rendered useless even if damaged just at a single place. For example, if one drive pin is pulled out, the track cannot be used nor repaired and thus rendered useless.

### SUMMARY

A continuous track with replaceable components described below permits a tracked vehicle to benefit from the cost savings associated with repairable tracks. Additionally, lighter weight continuous tracks with replaceable components may operate on more fragile surfaces such as turf without creating the damage often associated with repairable metal tracks. Each repairable track includes two parallel continuous belts, and each belt includes embedded plates to reinforce the belts and distribute the load applied by the vehicle drive train and the load applied by the shoe to the belts. Each shoe assembly engages the parallel belts and includes a track guide, a shoe plate and a shoe. The number, separation and orientation of the shoe assemblies are preset for a set of parallel belts, however shoe assemblies and the elements of the shoe assemblies may be used for many different belt sets. Any suitable fasteners may be used to secure each shoe assembly to the belts.

A continuous track with replaceable components described below includes shoes that may be formed of rubber, metal, a hybrid combination of rubber and metal or any other suitable material and may include any suitable traction surface which may adopt any suitable surface configuration to improve traction or minimize terrain destruction and or minimize shoe wear from the terrain.

### BRIEF DESCRIPTION OF THE DRAWINGS

FIG. 1 is a perspective view of a conventional loader with a continuous track with replaceable components.

FIG. 2 is a perspective view of an exploded portion of the continuous track of FIG. 1.

FIG. 3 is an exploded perspective view of elements of a single shoe assembly.

FIG. 4 is a cross-section view of the continuous track of FIG. 1 taken along A-A.

FIG. 5 is an cross-section view of an end of shoe the assembly of FIG. 4 taken along B-B.

FIG. 6 is an exploded view of the continuous track cross-section of FIG. 4.

FIG. 7 is a perspective view of a portion of an alternate continuous repairable rubber track.

FIG. 8 is a cross-section view of the track of FIG. 7 taken along C-C.

FIG. 9 is an exploded view of the continuous track cross-section of FIG. 8.

### DETAILED DESCRIPTION OF THE INVENTIONS

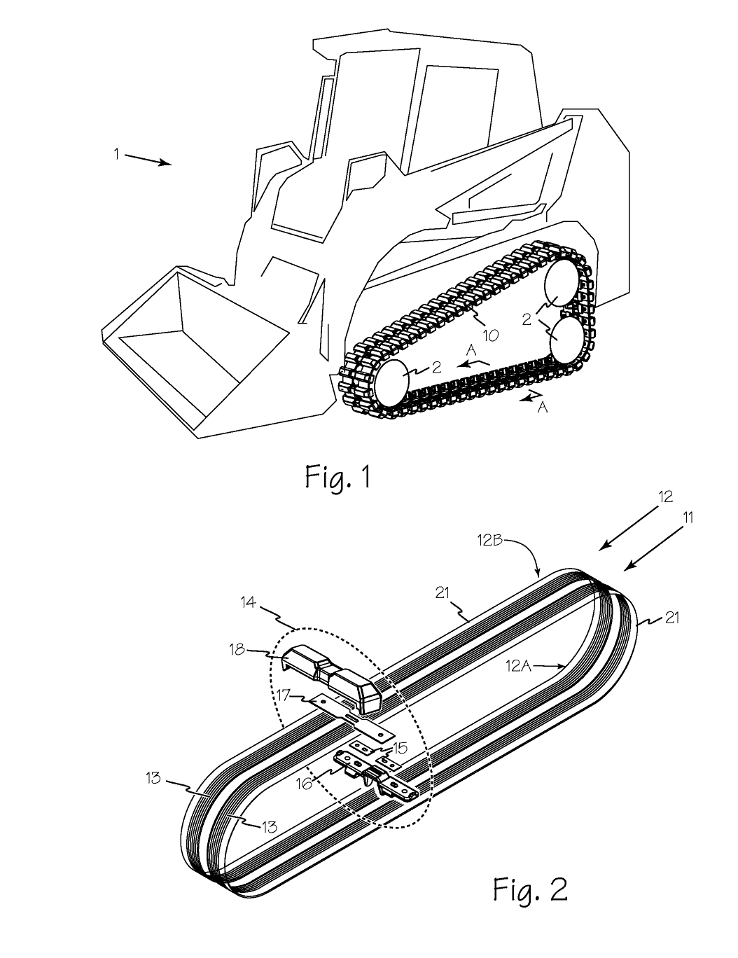

In tracked vehicles and equipment such as loader 1 of FIG. 1, locomotion is accomplished by supplying motive force through one or more drive elements such as drive wheels 2 which support and propel continuous track 10. Continuous track 10 with replaceable components described below permits a vehicle that was traditionally limited to metal tracks to benefit from the cost of maintenance, reduced vibration, and greater travel speeds of rubber tracks. The increased flexibility of continuous track 10 without the use of conventional pin and bushing moving parts, reduces the wear and vibration, thus allowing the track to last longer without the need for expensive maintenance. Additionally, the use of continuous track 10 on a vehicle that normally uses rubber tracks includes the benefit from the cost of an reparable rubber track. The flexibility and replaceable parts meet the demands of rubber tracks vehicles while having the capability of being repaired unlike traditional rubber tracks.

Continuous track 10 offers less maintenance costs because of fewer moving parts, substantially less weight which translates into fuel savings, longer life because no sand or debris can enter and destroy any moving and flexing parts. Less noise and vibration also result, and faster speeds are attainable as compared to the conventional steel tracks. The benefits and flexibility of continuous track 10 enables it to be used on any machine for which rubber tracks are suggested.

The proposed invention offers the equivalent flexibility as conventional rubber tracks. However, the proposed invention can be repaired unlike a conventional rubber track. In addition, the invention can be repaired not just once, but numerous times.

The larger the machine, the larger the track it requires. This means larger machines need larger rubber tracks that cost more money. This makes it financially risky to place rubber tracks on larger machines. If a large conventional rubber track is damaged in only one spot, then it is rendered useless even is the track was used for only one day. The total cost of the large track can be easily wasted. As a result, most machines over 10 tons in size use conventional steel tracks. If the steel track is damaged, it only needs to be repaired at the damaged area. This means that the majority of machines over 10 tons in weight are designed to only utilize conventional steel tracks, which means they are very heavy, cannot travel at high speed and they damage the surface on which they operate. Currently, only the rubber tracks allow for speeds over 10 Mph. Continuous track 10 will allow operation on larger tracked machines, such as those having 10 tons of weight and greater. These large, heavy machines will be able to reach higher speeds than previously considered possible.

Continuous track 10 of FIG. 2 is formed using replaceable components such as continuous belts 11 and 12 which are secured to any suitable number of shoe assemblies 14. Each shoe assembly includes two belt plates 15, a track guide 16, a shoe plate 17 and a shoe 18. Each shoe assembly is secured to each belt by at least one fastener securing track guide 16 to shoe 18 through belt 12, belt plate 15 and shoe plate 17. Track guides 16 engage drive elements 2.

Each belt 11 and 12 has an inner surface 11A or 12A, an outer surface 11B or 12B and an outside edge 11E or 12E and each of belts 11 and 12 is composed of a cable core 13 formed by a continuous, flexible metal cable forming a plurality of parallel loops embedded in any suitable flexible compound 21 such as natural or synthetic rubber blends and or polymer compounds or combinations of compounds and or blends. Alternatively, cable core 13 may be formed of one or more continuous belts of woven fabric or metal such as canvas, any other suitable alternative.

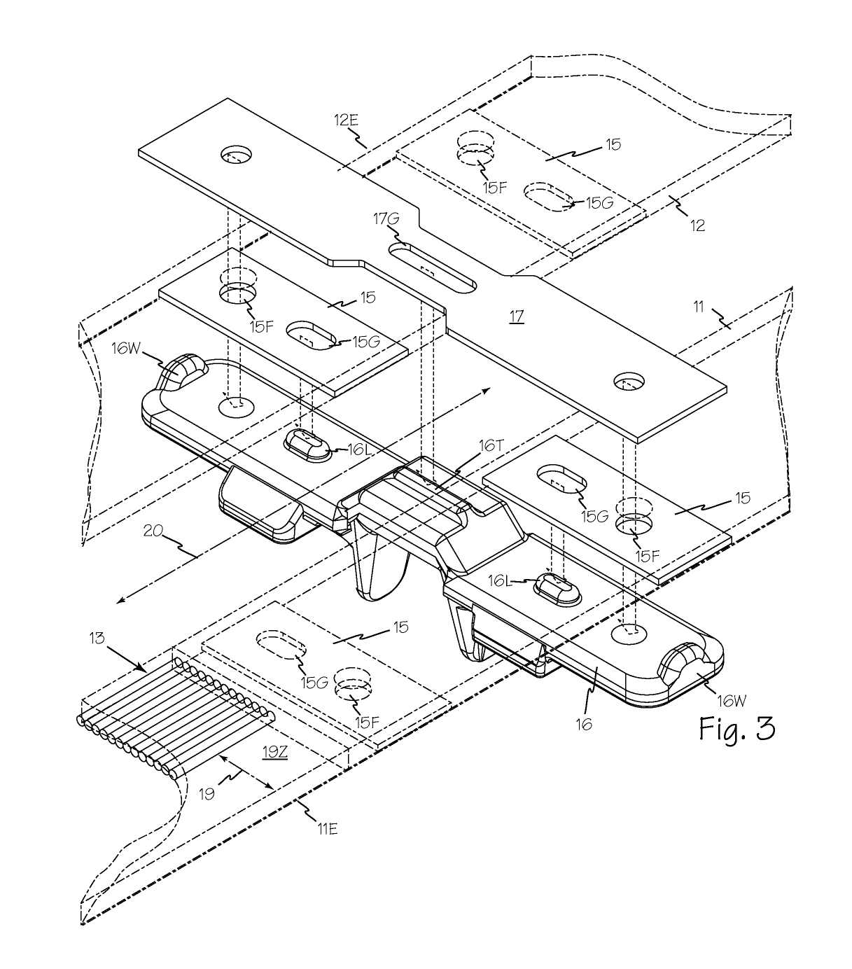

Referring now to FIG. 3, each continuous belt 11 and 12 has a suitable number of belt plates 15 embedded in inner surfaces 11A and 12A. Each belt plate has a fastener hole 15F and a guide hole 15G through the belt plate to help orient and lock each belt to track guide 16. The use of both fastener hole 15F and a guide hole 15G in each belt plate balances the driving forces applied to continuous belts 11 and 12. Core 13 is offset within each continuous belt close to, and parallel with, track centerline 20. Offset 19 is measured from outside edges 11E and 12E of belts 11 and 12 respectively, and is selected to enable a fastener inserted through fastener hole 15F to pass through the belt without contacting, cutting or passing through core 13. The open area between core 13 and outside edges 11E and 12E forms fastener zone 19Z which may be any suitable size.

To further secure track guide 16 to belts 11 and 12 and provide an even application of force to the belt, belt plates 15 include guide hole 15G oriented toward track centerline 20 and generally located in proximity to core 13. Each guide hole 15G engages a corresponding lug 16L on track guide 16. Similarly, shoe plate 17 includes guide slot 17G which is sized to engage tab 16T extending from the center of track guide 16.

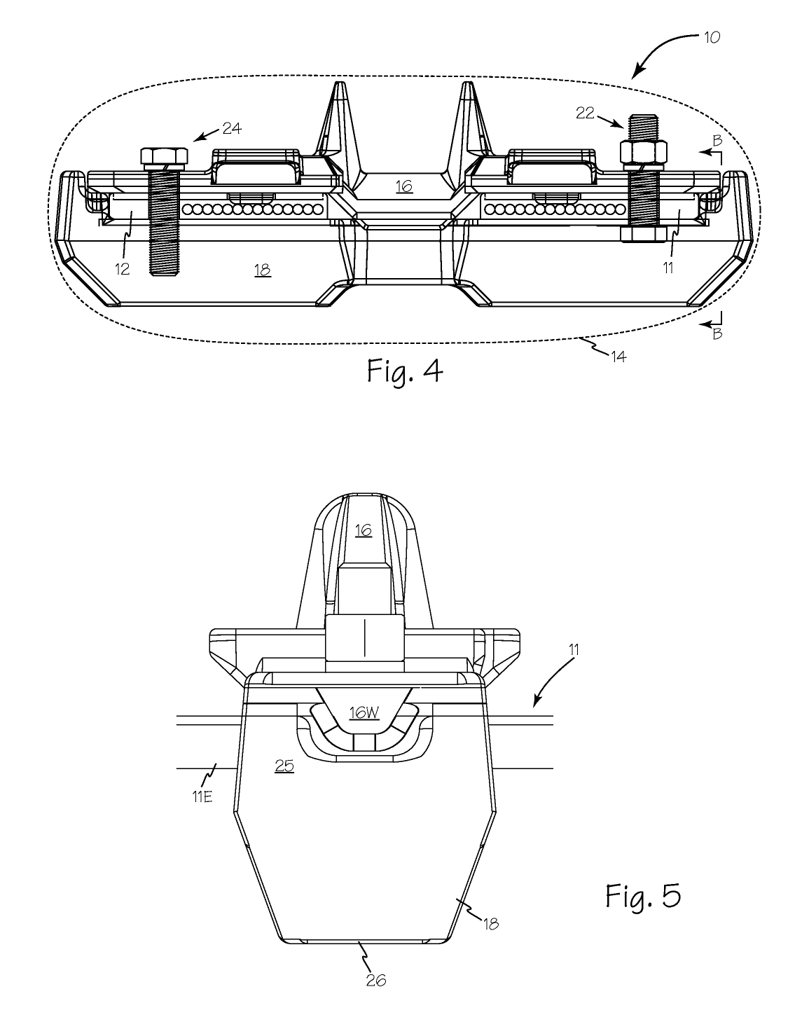

Referring now to FIG. 4, continuous track 10 is illustrated in cross-section through shoe assembly 14 which engages continuous belts 11 and 12 with fasteners 22 and 24. Alternate fastener configurations are shown for illustration. Fastener head 22H is embedded in shoe 18. Alternatively, shoe 18 may be threaded or otherwise configured to engage a fastener embedded in track guide 16, or inserted through track guide 16 such as fastener 24. Tab 16T may also extend through guide slot 17G and further engage a slot in shoe 18 such as slot 18S. Each shoe such as shoe 18 of continuous track 10 may be metal, rubber, a combination of rubber and metal or any other suitable material to optimize performance.

Referring now to FIG. 5, track guide 16 includes extended wings 16W which extend from the track guide to project over the edge of the continuous belt to protect the outside edge of the belt from abrasion in the work environment and also to retain the belt against forces pulling the belt out from between track guide 16 and shoe 18. To further protect and retain the belt, each shoe includes wings 25 which overlap and cover both the belt edge 11E and track guide wing 16W.

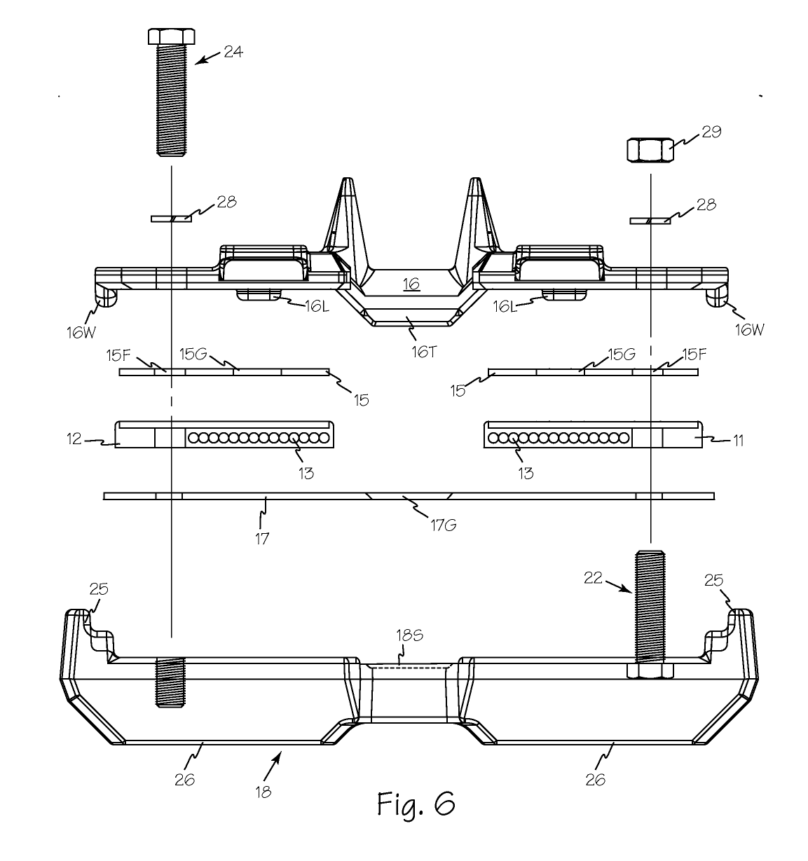

Referring now to FIG. 6, shoe assembly 14 is illustrated in an exploded view. Shoes such as shoe 18 may include any suitable traction surface such as sole 26 which may adopt any suitable surface configuration to improve traction or minimize terrain destruction and or minimize shoe wear from the terrain.

The interconnection of all the elements of the shoe assembly with the continuous belts and the fasteners retains the relative orientation of all the parts when in use and enables disassembly of one or more of the shoe assemblies of a track to replace any broken element from a continuous belt such as belt 11, belt plates 15, a track guide 16, a shoe 18, a shoe plate 17 or any fastener such as fastener 24. All fasteners may also include any suitable associated elements such as lock washers 28 and or nuts 29.

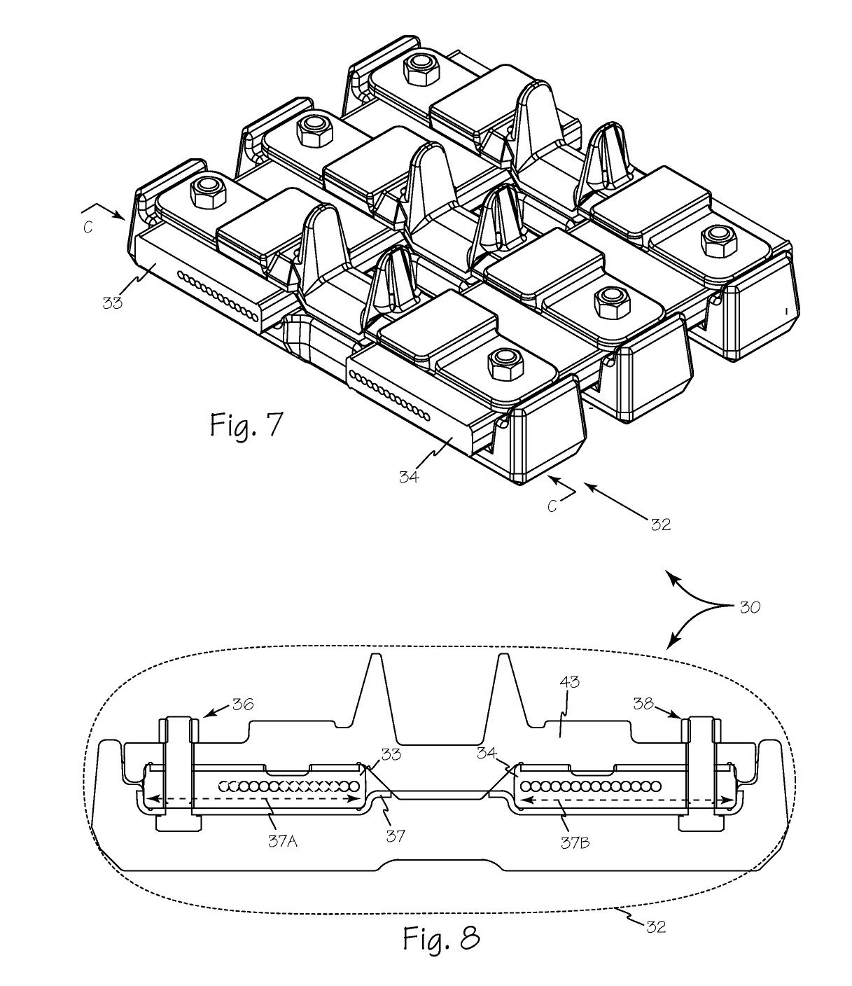

Referring now to FIGS. 7 and 8, alternate continuous track 30 is illustrated in cross-section through shoe assembly 32 which engages continuous belts 33 and 34 with fasteners 36 and 38. Shoe plate 37 is bent to form wells 37A and 37B to capture and engage belts 33 and 34 respectively.

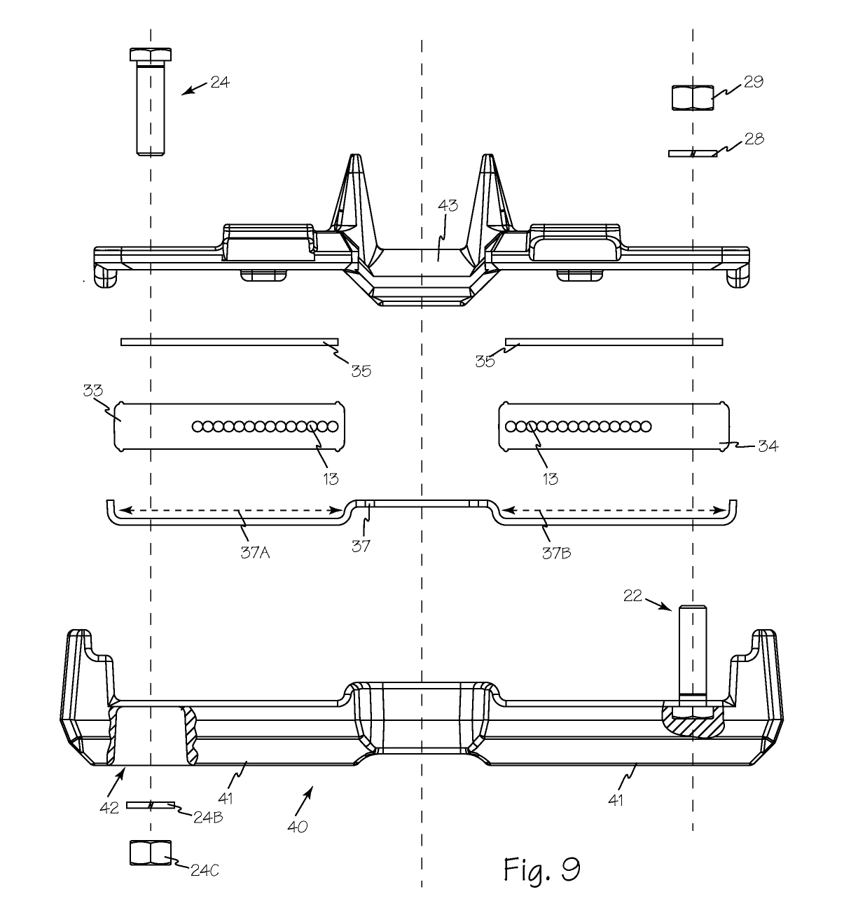

Referring now to FIG. 9, shoe assembly 32 is illustrated in an exploded view. Shoes such as shoe 40 may be formed of rubber, metal, a combination of rubber and metal or any other suitable material and may include any suitable traction surface such as sole 41 which may adopt any suitable surface configuration to improve traction or minimize terrain destruction and or minimize shoe wear from the terrain. Alternate fastener configurations are shown for illustration. Alternatively, shoe 40 may be threaded or otherwise configured with a suitable opening such as socket 42 for insertion of fastener elements 24B and 24C to engage fastener 24 inserted through track guide 43, belt 33 and shoe 40.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A track for a tracked vehicle comprising:
two flexible belts, each belt having an inner surface and an outer surface, each belt composed of a core formed by a continuous, flexible metal cable forming a plurality of parallel loops, a plurality of belt plates are aligned along the entire inner surface of the flexible belt, the core and the belt plates embedded within a flexible belt compound; and
a plurality of shoe assemblies removably secured to the two flexible belts, each shoe assembly engaging one of the plurality of belt plates of each flexible belt.

2. The track of claim 1 wherein each shoe assembly further comprises:
a shoe and an shoe plate secured to the outer surface of each belt;
a track guide secured to the inner surface of each belt; and
a least one fastener securing the shoe and shoe plate to a belt plate and the track guide through each flexible belt.

3. The track of claim 1 wherein the flexible belt compound is a blend of natural and synthetic compounds.

4. The track of claim 1 wherein the flexible belt compound is synthetic rubber.

5. The track of claim 1 wherein each flexible belt further comprises an outside edge and the core is offset from the outside edge forming an fastener zone between the core and the outside edge.

6. The track of claim 1 wherein the core is formed of woven fabric.

7. The track of claim 1 wherein the core is formed of woven metal belts.

8. The track of claim 2 wherein each flexible belt further comprises an outside edge and the core is offset from the outside edge forming an fastener zone between the core and the outside edge and each fastener secures the shoe and shoe plate to the belt plate and the track guide through the fastener zone of each flexible belt.
